(19) United States
(12) Patent Application Publication
(10) Pub. No.: US 2020/0047069 A1
(43) Pub. Date: Feb. 13, 2020

(54) Virtual motor vehicle controlling system and method

(71) Applicant: AAC Technologies Pte. Ltd., Singapore city (SG)

(72) Inventors: Xiuyue Wang, Shenzhen (CN); Yulei Zhang, Shenzhen (CN); Jianqi Li, Shenzhen (CN)

(21) Appl. No.: 16/530,948

(22) Filed: Aug. 2, 2019

(30) Foreign Application Priority Data
Aug. 13, 2018 (CN) 201810918774.0

(51) Int. Cl. A63F 13/42; A63F 13/218; A63F 13/285; A63F 13/803

(52) U.S. Cl. CPC A63F 13/42; A63F 13/803; A63F 13/285; A63F 13/218

(57) ABSTRACT

The present disclosure discloses a virtual motor vehicle engine controlling system, including a processor and a virtual motor vehicle engine electrically connected with the processor, the virtual motor vehicle engine controlling system further including a pressure acquisition sensor for acquiring a pressure data and a pressure threshold setter for setting pressure thresholds, the processor compares the pressure data acquired by the pressure acquisition sensor with the pressure thresholds set by the pressure threshold setter, and controls the virtual motor vehicle engine to feedback the manipulation states of the virtual motor vehicle engine according to the result of comparison, wherein the manipulation states comprise start, stop, acceleration, deceleration and uniform speed, the pressure thresholds set by the pressure threshold setter comprise limiting pressure threshold and triggering pressure threshold. The present invention further provides a virtual motor vehicle engine controlling method.

### FIELD OF THE PRESENT DISCLOSURE

The present invention relates to virtual motor vehicle technical field, and especially relates to a virtual motor vehicle engine controlling system and method.

### DESCRIPTION OF RELATED ART

The amount of intelligent mobile devices has been growing continuously with the advent of mobile Internet age. The attendant PC games, mobile games, mobile application softwares provided by racing car scenarios become more and more popular.

The virtual motor vehicle engine controlling system of related technology comprises a processor and the virtual motor vehicle engine controlled by the processor, the motion states of the virtual motor vehicle engine comprises start, stop, acceleration, deceleration and uniform speed. The processor controls the virtual motor vehicle engine to feedback the corresponding motion state through user's corresponding pressing operation.

However, in the virtual motor vehicle engine controlling system of related technologies, user can not obtain different pressing experiences through pressing operation. That is, the virtual motor vehicle engine gives the same feedback to the user under different pressing pressures, which lacks the sense of immersion and the sense of reality of pressing operation, causing poor user experience.

Thus, it is necessary to provide a new virtual motor vehicle engine controlling system a method which solve the above the technical problems.

### BRIEF DESCRIPTION OF THE DRAWINGS

Hereinafter, the figures required in the description of the embodiments will be briefly introduced, to describe the technical solutions in the embodiments of the present invention more clearly. It is evident that the figures described below are merely some of the embodiments of the present invention. For a person of ordinary skill in the art, other figures can be obtained according to these figures without applying inventive activity, in which figures:

FIG. 1 is a structure block view of the virtual motor vehicle engine controlling system of the present invention.

### DETAILED DESCRIPTION OF THE EXEMPLARY EMBODIMENT

Hereinafter, technical solutions in the embodiments of the present invention will be described clearly and completely, in conjunction with the figures in the embodiments of the present invention. It is evident that the described embodiments are merely part of the embodiments of the present invention, rather than all of the embodiments. Basing on the embodiments of the present invention, all other embodiments obtained by a person of ordinary skill in the art without applying inventive activity are all within the scope of protection of the present invention.

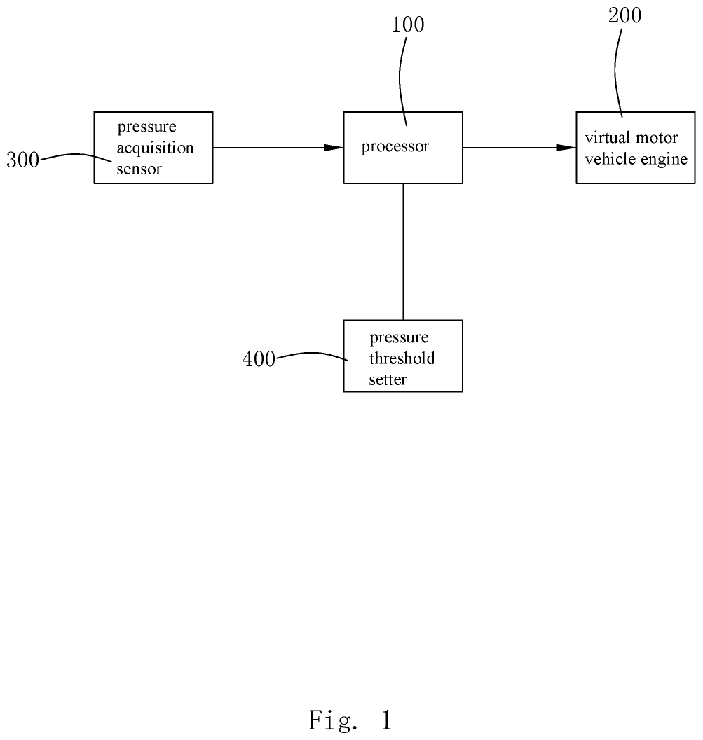

With reference to FIG. 1, the present invention provides a virtual motor vehicle engine controlling system including a processor 100, a virtual motor vehicle engine 200, a pressure acquisition sensor 300 and a pressure threshold setter 400.

The pressure acquisition sensor 300 is used to acquire a pressure data of pressing operation, the pressure acquisition sensor 300 signally connects with the processor 100 and transmits the pressure data of pressing operation to the processor 100.

The pressure threshold setter 400 is used to set pressure thresholds. The pressure thresholds set by the pressure threshold setter 400 comprises limiting pressure threshold and triggering pressure threshold.

The processor 100 electrically connects with the virtual motor vehicle engine 200. The processor compares the pressure data of pressing operation acquired by the pressure acquisition sensor 300 with the pressure thresholds set by the pressure threshold setter 400 and controls the virtual motor vehicle engine 200 to feedback the manipulation states of the virtual motor vehicle engine 200 according to the result of comparison. Sthe manipulation states comprise start, stop, acceleration, deceleration and uniform speed.

Therefore, the processor can control the virtual motor vehicle engine to feedback different manipulation sates to the user under different pressure of pressing operation by performing the comparison of the pressure data, thereby providing the sense of immersion and the sense of reality of pressure operation, and improving the user experience.

Specifically, the virtual motor vehicle engine 300 comprises a virtual motor vehicle engine manipulation interface (not shown) used to provide pressing operation to user and feedback manipulation states to the user.

The present invention further provides a virtual motor vehicle engine control method including the following steps:

step S1, providing the virtual motor vehicle engine controlling system described in the present invention;

step S2, setting the triggering pressure threshold P_{C1} and the limiting pressure threshold P_{C2} through the pressure threshold setter;

step S3, acquiring real-time pressure P_{X} of the pressing operation through the pressure acquisition sensor 300, receiving the real-time pressure P_{X} through the processor 100, and comparing the real-time pressure P_{X} with the triggering pressure threshold P_{C1} and the limiting pressure threshold P_{C2} according to the predetermined rule and generating a controlling signal, and controlling the virtual motor vehicle engine 200 to feedback the motion state through the controlling signal.

In this embodiment, the predetermined rule includes:
when P_{X}≥P_{C1}, the processor 100 controls the virtual motor vehicle engine 200 to feedback that the virtual motor vehicle engine 200 is in the start sate;
when P_{X}≤P_{C1}, the processor 100 controls the virtual motor vehicle engine 200 to feedback that the virtual motor vehicle engine 200 is in the stop sate;
when P_{X}≥P_{C2}, the processor controls the virtual motor vehicle engine 200 to feedback that the virtual motor vehicle engine 200 is under the maximum motion speed and keeping uniform speed state;
when P_{C2}>P_{X}>P_{C1}, and P_{X} is increasing gradually, the processor 100 controls the virtual motor vehicle engine 200 to feedback that the virtual motor vehicle engine 200 is in the acceleration state;
when P_{C2}>P_{X}>P_{C1}, and P_{X} is decreasing gradually, the processor 100 controls the virtual motor vehicle engine 200 to feedback that the virtual motor vehicle engine 200 is in the deceleration state;
when P_{C2}>PX>P_{C1}, and P_{X} keeps constant, the processor 100 controls the virtual motor vehicle engine 200 to feedback that the virtual motor vehicle engine 200 entered the uniform speed state at current speed.

Compared to the prior art, in the virtual motor vehicle engine controlling system and method provided by the present invention, the pressure acquisition sensor acquires the pressure data, the pressure threshold setter sets the limiting pressure threshold and the triggering pressure threshold, the processor compares the pressure data, the limiting pressure threshold and the triggering pressure threshold, and controls the virtual motor vehicle engine to feedback the manipulation state in which the virtual motor vehicle engine is. Therefore, pressing operations under different pressures may obtain different manipulation state of the virtual motor vehicle engine, providing the sense of immersion and the sense of reality of pressing operation, and improving the user experience.

However, that mentioned above are merely embodiments of the present invention, and not so limiting the patentable scope of the present invention. Equivalent structures or equivalent process transformations, or direct or indirect application in other related fields made using the specification and the drawings of the present invention, are therefore all contained in the scope of patent protection of the present invention for the same reason.

What is claimed is:

1. A virtual motor vehicle engine controlling system, including a processor and a virtual motor vehicle engine electrically connected with the processor, wherein the virtual motor vehicle engine controlling system further including a pressure acquisition sensor for acquiring a pressure data and a pressure threshold setter for setting pressure thresholds, the processor compares the pressure data acquired by the pressure acquisition sensor with the pressure thresholds set by the pressure threshold setter, and controls the virtual motor vehicle engine to feedback manipulation states of the virtual motor vehicle engine according to the result of comparison, wherein the manipulation states comprise start, stop, acceleration, deceleration and uniform speed, the pressure thresholds set by the pressure threshold setter comprise limiting pressure threshold and triggering pressure threshold.

2. The virtual motor vehicle engine controlling system as described in claim 1, wherein the virtual motor vehicle engine comprises a virtual motor vehicle engine manipulation interface used to provide pressing operation and feedbacking the manipulation states.

3. A virtual motor vehicle engine control method, characterized by including the following steps:
step S1, providing the virtual motor vehicle engine controlling system as described in claim 1;
step S2, setting the triggering pressure threshold P_{C1} and the limiting pressure threshold P_{C2} through the pressure threshold setter;
step S3, acquiring real-time pressure P_{X} of the pressing operation through the pressure acquisition sensor, receiving the real-time pressure P_{X} through the processor, and comparing the real-time pressure P_{X} with the triggering pressure threshold P_{C1} and the limiting pressure threshold P_{C2} according to the predetermined rule and generating a controlling signal, and controlling the virtual motor vehicle engine to feedback the motion state through the controlling signal.

4. The virtual motor vehicle engine control method according to claim 3, wherein the predetermined rule including:
when P_{X}≥P_{C1}, the processor controls the virtual motor vehicle engine to feedback that the virtual motor vehicle engine is in the start sate;
when P_{X}≤P_{C1}, the processor controls the virtual motor vehicle engine to feedback that the virtual motor vehicle engine is in the stop sate;
when P_{X}≥P_{C2}, the processor controls the virtual motor vehicle engine to feedback that the virtual motor vehicle engine is under the maximum motion speed and keeping uniform speed state;
when P_{C2}>P_{X}>P_{C1}, and P_{X} is increasing gradually, the processor controls the virtual motor vehicle engine to feedback that the virtual motor vehicle engine is in the acceleration state;
when P_{C2}>P_{X}>P_{C1}, and P_{X} is decreasing gradually, the processor controls the virtual motor vehicle engine to feedback that the virtual motor vehicle engine is in the deceleration state;
when P_{C2}>P_{X}>P_{C1}, and P_{X} keeps constant, the processor controls the virtual motor vehicle engine to feedback that the virtual motor vehicle engine entered the uniform speed state at current speed.

5. A virtual motor vehicle engine control method, characterized by including the following steps:
step S1, providing the virtual motor vehicle engine controlling system as described in claim 2;
step S2, setting the triggering pressure threshold P_{C1} and the limiting pressure threshold P_{C2} through the pressure threshold setter;
step S3, acquiring real-time pressure P_{X} of the pressing operation through the pressure acquisition sensor, receiving the real-time pressure P_{X} through the processor, and comparing the real-time pressure P_{X} with the triggering pressure threshold P_{C1} and the limiting pressure threshold P_{C2} according to the predetermined rule and generating a controlling signal, and controlling the virtual motor vehicle engine to feedback the motion state through the controlling signal.

6. The virtual motor vehicle engine control method according to claim 5, wherein the predetermined rule including:
when P_{X}≥P_{C1}, the processor controls the virtual motor vehicle engine to feedback that the virtual motor vehicle engine is in the start sate;
when P_{X}≤P_{C1}, the processor controls the virtual motor vehicle engine to feedback that the virtual motor vehicle engine is in the stop sate;
when P_{X}≥P_{C2}, the processor controls the virtual motor vehicle engine to feedback that the virtual motor vehicle engine is under the maximum motion speed and keeping uniform speed state;
when P_{C2}>P_{X}>P_{C1}, and P_{X} is increasing gradually, the processor controls the virtual motor vehicle engine to feedback that the virtual motor vehicle engine is in the acceleration state;
when P_{C2}>P_{X}>P_{C1}, and P_{X} is decreasing gradually, the processor controls the virtual motor vehicle engine to feedback that the virtual motor vehicle engine is in the deceleration state;
when P_{C2}>P_{X}>P_{C1}, and P_{X} keeps constant, the processor controls the virtual motor vehicle engine to feedback that the virtual motor vehicle engine entered the uniform speed state at current speed.
